(19) United States
(12) Patent Application Publication
(10) Pub. No.: US 2023/0400598 A1
(43) Pub. Date: Dec. 14, 2023

(54) ITERATIVE WELL LOG DEPTH SHIFTING

(71) Applicant: Chevron U.S.A. Inc., San Ramon, CA (US)

(72) Inventors: Mason C. Edwards, Houston, TX (US); Joshua S. Hoskinson, Houston, TX (US); Sandra C. Saldana, Cypress, TX (US); Donald Neal Burch, Englewood, CO (US)

(21) Appl. No.: 17/826,400

(22) Filed: May 27, 2022

(51) Int. Cl. G01V 1/50; G06N 20/00

(52) U.S. Cl. CPC G01V 1/50; G01V 2210/60; G06N 20/00

(57) ABSTRACT

A reference curve may be used as the goal for alignment when depth shifting one or more target well logs. Traditionally the reference curve has been measured data, and is usually of the same measurement type as the well log for shifting when performed algorithmically. The reference curve may be generated by a weak learner machine learning model. The weak learner machine learning model may preserve shape characteristics and depth information of one or more input curves in the reference curve. Depth shifting of a target well log may be performed by iteratively using sliding correlation windows of differing sizes.

### FIELD

The present disclosure relates generally to the field of well log depth shifting.

### BACKGROUND

Well logs for a subsurface region may be misaligned in depth. Misalignment of well logs may result in inaccurate interpretation of subsurface properties in the subsurface region. Alignment of well logs may be difficult, time consuming, and prone to subjectivity of the person performing the alignment.

### SUMMARY

This disclosure relates to iterative well log depth shifting. Reference well log information, target well log information, and/or other information may be obtained. The reference well log information may define a set of reference well logs. The target well log information may define a set of target well logs. A reference curve for depth shifting may be determined based on the set of reference well logs and/or other information. A set of depth-shifted well logs may be generated by performing depth shifting of the set of target well logs using the reference curve and/or other information. The depth shifting may include iterative use of sliding correlation windows of differing sizes.

A system for iterative well log depth shifting may include one or more electronic storage, one or more processors and/or other components. The electronic storage may store reference well log information, information relating to reference well logs, target well log information, information relating to target well logs, information relating to reference curves, information relating to depth shifting, information relating to depth-shifted well logs, and/or other information.

The processor(s) may be configured by machine-readable instructions. Executing the machine-readable instructions may cause the processor(s) to facilitate iterative well log depth shifting. The machine-readable instructions may include one or more computer program components. The computer program components may include one or more of a reference well log component, a target well log component, a reference curve component, a depth-shift component, and/or other computer program components.

The reference well log component may be configured to obtain reference well log information and/or other information. The reference well log information may define one or more sets of reference well logs.

The target well log component may be configured to obtain target well log information and/or other information. The target well log information may define one or more sets of target well logs.

The reference curve component may be configured to determine one or more reference curves for depth shifting. The reference curve(s) may be determined based on the set(s) of reference well logs and/or other information.

In some implementations, determination of a reference curve for depth shifting may include generation of a synthetic reference curve. The synthetic reference curve may be generated using a weak learner machine learning model. In some implementations, the weak learner machine learning model may be trained using one or more input reference well logs as input features and a given target well log as a regression objective. In some implementations, the weak learner machine learning model may preserve shape characteristics of the input reference well log(s) in the synthetic reference curve.

In some implementations, the input reference well log(s) may include one or more reference well logs from the set(s) of reference well logs. In some implementations, the input reference well log(s) may include one or more depth-shifted well logs.

The depth-shift component may be configured to generate one or more sets of depth-shifted well logs. A set of depth-shifted well logs may be generated by performing depth shifting of a set of target well logs using a reference curve and/or other information. The depth shifting may include iterative use of sliding correlation windows of differing sizes. In some implementations, the sliding correlation windows of differing sizes may include sliding correlation windows of decreasing sizes.

In some implementations, a given sliding correlation window may be used to determine a depth shift for a given target well log based on a cross-correlation between the given target well log and the reference curve for depth shifting. In some implementations, multiple depth shifts at different scales for the given target well log may be combined to perform depth shifting of the given target well log to generate a given depth-shifted well log.

In some implementations, a bulk shift may be applied to a given target well log before the iterative use of sliding correlation windows of differing sizes.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for iterative well log depth shifting.

FIG. 2 illustrates an example method for iterative well log depth shifting.

FIG. 3 illustrates an example process for iterative well log depth shifting.

FIG. 4 illustrate example reference curve, aligned curve, target curve, and synthetic curve.

FIG. 5 illustrates example well log depth shifting.

FIG. 6 illustrates example well log depth shifting.

### DETAILED DESCRIPTION

The present disclosure relates to iterative well log depth shifting. A reference curve may be used as the goal for alignment when depth shifting one or more target well logs. Traditionally the reference curve has been measured data, and is usually of the same measurement type as the well log for shifting when performed algorithmically. The reference curve may be generated by a weak learner machine learning model. The weak learner machine learning model may preserve shape characteristics and depth information of one or more input curves in the reference curve. Depth shifting of a target well log may be performed by iteratively using sliding correlation windows of differing sizes.

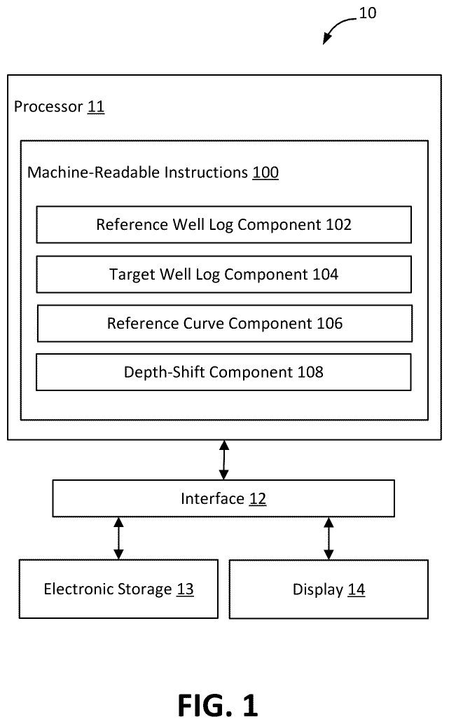

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Reference well log information, target well log information, and/or other information may be obtained by the processor 11. The reference well log information may define a set of reference well logs. The target well log information may define a set of target well logs. A reference curve for depth shifting may be determined by the processor 11 based on the set of reference well logs and/or other information. A set of depth-shifted well logs may be generated by the processor 11 by performing depth shifting of the set of target well logs using the reference curve and/or other information. The depth shifting may include iterative use of sliding correlation windows of differing sizes.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store reference well log information, information relating to reference well logs, target well log information, information relating to target well logs, information relating to reference curves, information relating to depth shifting, information relating to depth-shifted well logs, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present reference well log information, information relating to reference well logs, target well log information, information relating to target well logs, information relating to reference curves, information relating to depth shifting, information relating to depth-shifted well logs, and/or other information.

Interpretations of subsurface characteristics (e.g., petrophysical interpretations) may rely on sample-to-sample calculations between multiple well logs. However, well logs may be misaligned in depth. Well logs may be misaligned due to a variety of reasons, such as, (1) acquisition of data in multiple passes over a hole section, (2) acquisition of data in partially overlapping adjacent hole sections, (3) acquisition of data using different conveyance methods (e.g., wireline vs LWD), and (4) adverse hole conditions leading to stick-slip and oscillating measurement sondes. Misalignment of well logs in depth may lead to inaccurate interpretation of subsurface characteristics. For example, well logs that are misaligned by a fraction of a meter to a few meters may result in erosion of the resolution and fidelity of interpretations.

Manual alignment of well logs may be difficult, prone to subjectivity of the person performing the aliment, and require a significant amount of time, delaying real-time operational decision making. Automatic alignment of well logs may be performed to automate depth shifting of like well logs/curves (e.g., of same measurement type). The terms “well log” and “curve” may be used interchangeably. However, such methods may be of limited use as redundant measurements may not be available or well logs requiring depth alignment may be insufficiently correlated. Thus, such methods may only work in a select number of cases and may rarely work to align well logs of different types. For example, neutron log and gamma log may not be correlated, and existing automatic alignment methods may not be able to depth align these different types of well logs. Additionally, automatic alignment methods may be sensitive to the ways in which well logs are acquired, and differences in signal-to-noise ratio (e.g., due to data acquisition at different speeds) may introduce enough noise into the well logs to prevent accurate depth alignment.

The present disclosure provides a tool to automatically perform depth alignment of well logs. For well logs of measurement types different from available reference well logs (non-like well logs), a synthetic reference curve is generated using a weak learner machine learning model. The synthetic reference curve generated by the weak learner machine learning model inherits shape characteristics and depth information from the reference curves. The synthetic reference curve provides an “on-depth” version of the well log that is to be shifted. The synthetic reference curve of the present disclosure enables accurate depth alignment of non-like well logs. The synthetic reference curve offers improvement in stability of mapping to the reference curve and becomes measurement type agnostic. Use of the synthetic reference curves enables well logs to be accurately depth shifted even when same type of reference well logs are not available and/or the well logs have poor correlation with the available reference well logs. Depth shifts between a well log and a reference curve (e.g., another well log, a synthetic reference curve) may be computed by iteratively using smaller sliding correlation windows. Use of smaller correlation windows enables depth shifts to be more localized with each iteration.

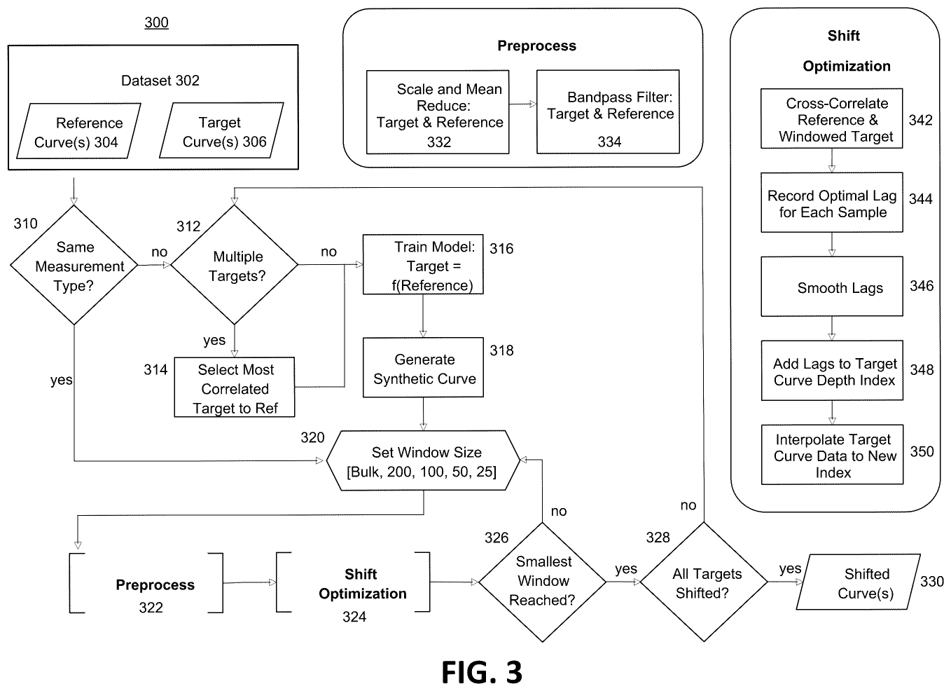

FIG. 3 illustrates an example process 300 for iterative well log depth shifting. A dataset 302 may include one or more reference curves 304 and one or more target curve(s) 306. The reference curve(s) 304 may include one or more well logs to be used as a reference for depth shifting and the target curve(s) 306 may include one or more well logs to be depth shifted.

At a step 310, measurement type(s) of the reference curve(s) 304 and the target curve(s) 306 may be compared to determine whether they are the same measurement type or different measurement types. If they are the same measurement type, the process 300 may continue to step 320. If a reference curve and a target curve are of the same measurement type, then a synthetic curve does not need to be generated. One of the reference curve(s) 304 may be selected as the reference curve to be used for depth shifting. If they are different measurement types, the process 300 may continue to step 312.

At step 312, number of remaining target curve(s) 306 to be depth shifted may be determined. If a single target curve remains, the process 300 may continue to step 316. If multiple target curves remain, the process 300 may continue to step 314.

At step 314, the target curves may be compared to one or more reference curves. The target curve that is most correlated to the reference curve(s) may be selected for depth shifting. That is, when multiple target curves are to be depth shifted, the depth shifting may begin with the target curve that is most correlated to the reference curve(s).

At step 316 a weak learner machine learning model is trained. The weak learner

machine learning model may be a regression model. The weak learner machine learning model may be trained using one or more reference curves as the input feature(s) and the target curve selected for depth shifting as the regression objective.

At step 318, the weak learner machine learning model may be used to generate a synthetic curve (synthetic reference curve). The synthetic curve output by the weak learner machine learning model may be a low-quality synthetic copy of the target curve. The synthetic curve may inherit shape characteristics (e.g., plateaus, dips, troughs, rises, peaks) and depth information (e.g., locations of plateaus, dips, troughs, rises, peaks) from the reference curve(s). While the absolute values of the synthetic curve may be a poor substitute for the target curve (measured well log to be depth shifted), the synthetic curve may be more like the target curve than any of the existing reference curves (e.g., the reference curve(s) 304), making the synthetic curve more appropriate for correlation-based depth shifting of the target curve.

At step 320, the size of the sliding correlation windows may be set. The sliding correlation window may be used to determine correlation between different parts/segments of the target curve and the reference curve (e.g., selected reference curve, synthetic curve). The size of the sliding correlation window may be decreased with each iteration—after bulk shifting, the size of the sliding correlation window may become smaller and smaller. In some implementations, the size of the sliding may be set based on user input. Within an iteration, the size of the sliding correlation window may be held constant. In FIG. 3, example decreasing sizes of the sliding correlation window are shown as 200 ft, 100 ft, 50 ft, and 25 ft. Other sizes of sliding correlation window are contemplated.

At step 322, the target curve and the reference curve may be preprocessed. Preprocessing may include scale and mean reduction 332. The target curve and/or the reference curve may be scaled to unit variance and mean centered about zero. This may mitigate the effect of poor predictions of the target curve magnitude within the synthetic curve used as the reference curve. Preprocessing may include application of one or more bandpass filters 334. The target curve and/or the reference curve may be bandpass filtered within the sliding correlation window to mitigate any effects of noise and/or resolution mismatch between the target curve and the reference curve. Bandpass filtering may remove fine noise from the curves and enable depth shifting to be performed based on prominent features in the curves (rather than noise).

At step 324, shift optimization may be performed. Shift optimization may include computation of the cross-correlation between different segments of the reference curve and the target curve 342, with the segments for computation determined based on movement of the sliding correlation window over the curves. Convolutional analysis may be used to determine cross-correlation between different segments of the reference curve and the target curve. The optimal lag (shifting direction and amount) between the reference curve and the target curves may be determined and recorded for individual sample depth locations 344. Bulk shift may initially be determined to perform initial shifting (bulk shifting, static shifting) of the target curve to the reference curve. Then, sliding correlation windows of decreasing sizes may be iteratively used to compute optimal lags from the cross-correlation. Once optimal lags are determined for the sampled depth locations, the optimal lags at different depth locations may be smoothed. Smoothing may prevent non-physical “over-shifting” in the shifted curve (e.g., prevent an upper point of the curve from being shifted below a lower point of the curve, or prevent a lower point of the curve from being shifted above an upper point of the curve). The smoothed lags may be added to a target curve depth index 348 (add shifts to the depth reference of the target curve). Target curve data may be interpolated to a new index 350 (interpolate the target curve to the new depth reference using the shifts added to the depth reference of the target curve).

At step 326, if the smallest sliding correlation window size has not been used, the process 300 may return to step 320, where the sliding correlation window is set to a smaller size. For subsequent iterations within the process 300, previously shifted target curve(s) may be used. For example, after a target curve has been shifted using a sliding correlation window of size 200, the shifted target curve may be further shifted in the next iteration using a sliding correlation window of size 100. If the smallest window size has been used, the process 300 may continue to step 328. At step 328, if all of the target curves have been shifted, the process 300 may end with one or more shifted curves 300. If not all of the target curves have been shifted, the process 300 may return to step 312.

After iterative shifting of a target curve has been completed, the shifted target curve may be used as a reference curve. For example, after a target curve has been shifted multiple times using sliding correlation windows of decreasing sizes, the shifted target curve may be used as an input feature in training the weak learner machine learning model. Thus, iterative shifting of target curves may increase the number of reference curves available for training the weak learner machine learning model.

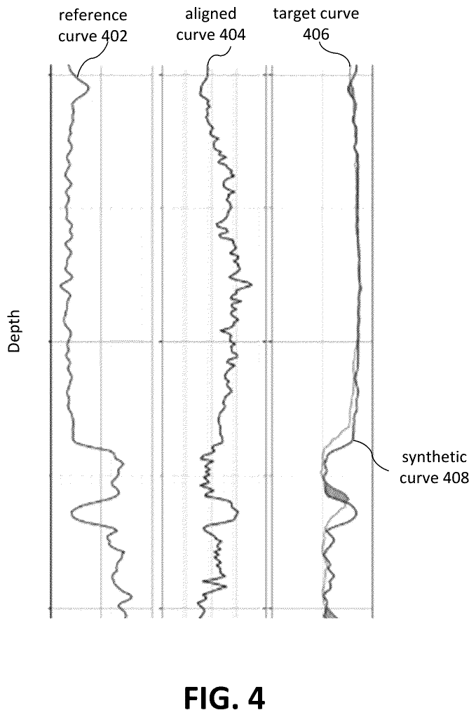

FIG. 4 illustrate example reference curve 402, aligned curve 404, target curve 406, and synthetic curve 408. The reference curve 402 may refer to a curve (well log) that has been selected as a reference for depth shifting of other curves (other well logs). The aligned curve 404 may include a curve that has previously been depth shifted. The target curve 406 may refer to a curve that is to be depth shifted. The synthetic curve 408 may refer to a reference curve that has been synthetized to depth shift the target curve 406. The synthetic curve 408 may be generated by a weak learner machine learning model, which has been trained using the reference curve 402 and the aligned curve 404 as input features and the target curve 406 as the regression objective.

The weak learner machine learning model may capture the relationships between the reference curve 402, the aligned curve 404, and the target curve 406 in the synthetic curve 408 (synthetic version of the target curve 406). The overall shape of the synthetic curve 408 may be determined based on the overall shape of the reference curve 402 and the aligned curve 404—for example, the location and shape of troughs and peaks of the reference curve 402 and the aligned curve 404 may be used to determine the location and shape of troughs and peaks of the synthetic curve 408, while the direction of changes in the synthetic curve 408 matches the direction of changes in the target curve 406.

For example, in FIG. 4, the synthetic curve 408 may have a trough and a peak. The trough of the synthetic curve 408 may inherit the shape (e.g., slope) and location of a peak in the reference curve 402 and a trough in the aligned curve 404. The peak of the synthetic curve 408 may inherit the shape and location of a trough in the reference curve 402 and a peak in the aligned curve 404. The synthetic curve 408 may first include the trough and then the peak as it is a synthetic version of the target curve 406. Thus, while the changes in the shape of the synthetic curve 408 (absolute value of slope) may be derived from the reference curve 402 and the aligned curve 404, the direction in which the shape of the curve changes (whether the curve rises or falls) is derived from the target curve 406.

Correlation between the synthetic curve 408 and the target curve 406 may be higher than correlation between the reference curve 402 and the target curve 406. Use of the synthetic curve 408 as the reference for depth shifting may result in more accurate depth shifting of the target curve 406 than use of the reference curve 402 as the reference.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to iterative well log depth shifting. The machine-readable instructions 100 may include one or more computer program components. The machine-readable instructions 100 may include a reference well log component 102, a target well log component 104, a reference curve component 106, a depth-shift component 108, and/or other computer program components.

The reference well log component 102 may be configured to obtain reference well log information and/or other information. Obtaining reference well log information may include one or more of accessing, acquiring, analyzing, creating, determining, examining, generating, identifying, loading, locating, measuring, opening, receiving, retrieving, reviewing, selecting, storing, utilizing, and/or otherwise obtaining the reference well log information. The reference well log component 102 may obtain reference well log information from one or more locations. For example, the reference well log component 102 may obtain reference well log information from a storage location, such as the electronic storage 13, electronic storage of a device accessible via a network, and/or other locations. The reference well log component 102 may obtain reference well log information from one or more hardware components (e.g., a computing device, a component of a computing device) and/or one or more software components (e.g., software running on a computing device).

In some implementations, the reference well log information may be obtained from one or more users. For example, a user may interact with a computing device to input, upload, identify, and/or select the well logs to be used as reference curves for depth shifting, and the reference well log information for the well logs may be obtained. The reference well log information may be stored within a single file or multiple files.

The reference well log information may define one or more sets of reference well logs. A set of reference well logs may include one or more reference well logs. A well log may refer to a measurement (versus depth and/or time) of one or more physical quantities in and/or around a well. A well log may be defined by a curve, with the shape and magnitude of the curve indicating one or more subsurface properties at different locations and/or times. A reference well log may refer to a well log that may be selected to function as a reference in depth shifting one or more well logs. A reference well log may refer to a well log to which other well log(s) may be aligned. A reference well log may include a real well log or a synthetic well log. A reference well log may include and/or be referred to as a reference curve.

The reference well log information may define a reference well log by including information that defines one or more content, qualities, attributes, features, and/or other aspects of the reference well log. For example, the reference well log information may define a reference well log by including information that makes up the curve of a measured attributed in/around a well and/or information that is used to determine the curve of the measured attributed in/around the well. Other types of reference well log information are contemplated.

The target well log component 104 may be configured to obtain target well log information and/or other information. Obtaining target well log information may include one or more of accessing, acquiring, analyzing, creating, determining, examining, generating, identifying, loading, locating, measuring, opening, receiving, retrieving, reviewing, selecting, storing, utilizing, and/or otherwise obtaining the target well log information. The target well log component 104 may obtain target well log information from one or more locations. For example, the target well log component 104 may obtain target well log information from a storage location, such as the electronic storage 13, electronic storage of a device accessible via a network, and/or other locations. The target well log component 104 may obtain target well log information from one or more hardware components (e.g., a computing device, a component of a computing device) and/or one or more software components (e.g., software running on a computing device).

In some implementations, the target well log information may be obtained from one or more users. For example, a user may interact with a computing device to input, upload, identify, and/or select the well logs to be used as target curves for depth shifting (target curves to be depth shifted), and the target well log information for the well logs may be obtained. The target well log information may be stored within a single file or multiple files.

The target well log information may define one or more sets of target well logs. A set of target well logs may include one or more target well logs. A target well log may refer to a well log that may be aligned to a reference well log. A target well log may refer to a well log that is to be depth shifted. A target well log may include a real well log or a synthetic well log. A target well log may include and/or be referred to as a target curve.

The target well log information may define a target well log by including information that defines one or more content, qualities, attributes, features, and/or other aspects of the target well log. For example, the target well log information may define a target well log by including information that makes up the curve of a measured attributed in/around a well and/or information that is used to determine the curve of the measured attributed in/around the well. Other types of target well log information are contemplated.

The reference curve component 106 may be configured to determine one or more reference curves for depth shifting. A reference curve may be determined for depth shifting one or more target curves. Determining a reference curve for depth shifting may include ascertaining, approximating, calculating, establishing, estimating, generating, finding, identifying, obtaining, quantifying, selecting, and/or otherwise determining the reference curve for use in depth shifting the target curve(s). Different reference curves may be determined by the reference curve component 106 for depth shifting of different target curves. A reference curve may refer to a curve that will be used as a reference in depth shifting one or more target well logs. A reference curve may refer to curve to which other curves (of target well logs) may be aligned. A reference curve may refer to a curve from which depth scaling is used for depth shifting.

The reference curve(s) may be determined based on the set(s) of reference well logs and/or other information. In some implementations, one of the reference well logs may be used as a reference curve. A reference well log may be used as a reference curve when the type of the reference well log and the type of the target well log are the same. For example, a set of reference well logs may include reference well logs of different measurement types. A particular reference well log may be selected as the reference curve based on the particular reference well log being the same measurement type as the target well log being depth shifted. For example, a target well log may include a gamma ray curve, and a set of reference well logs may include a reference gamma ray curve. The reference gamma ray curve may be selected to depth shift the target gamma ray curve.

In some implementations, determination of a reference curve for depth shifting may include generation of a synthetic reference curve. A synthetic reference curve may refer to a computer-generated reference curve. Rather than using one of the existing reference well logs as the reference curve, a synthetic reference curve may be generated for depth shifting of a target well log. A synthetic reference curve may be generated when the types of available reference well logs and the type of the target well log are not the same. A synthetic reference curve may be generated when available reference well logs do not correlate well with the target well log. For example, if the correlation between the target well log and the available reference well logs are below a threshold value, a synthetic reference curve may be generated to depth shift the target well log.

The synthetic reference curve may be generated using a weak learner machine learning model. A weak learner machine learning model may refer to a machine learning model that has been weakly trained. A weak learner machine learning model may refer to a machine learning model with low predictive skill. A weak learner machine learning model may refer to a machine learning model that is underfitted. A weak learner machine learning model may refer to a machine learning model with high bias.

In some implementations, the weak learner machine learning model may be trained using one or more input reference well logs as input features and a target well log to be depth shifted as a regression objective. The input reference well log(s) may include one or more reference well logs from the set(s) of reference well logs, one or more depth-shifted well logs, and/or other well logs. The curves of the reference well logs and/or curves of target well logs that have been depth shifted may be used as input features of the weak learner machine learning model. Misalignment between the target well log and the reference well logs/depth-shifted well log may result in weak training of the weak learner machine learning model. In some implementations, the weak learner machine learning model may include a regression model, such as a support vector regression. Use of other types of machine learning models are contemplated.

The weak learner machine learning model may utilize the input reference well log(s) (e.g., reference well logs, depth-shifted well logs) to predict the target well log to be depth shifted. Same data may be used to train and to operate the weak learner machine learning model. That is, the training data for the weak learner machine learning model may be the same as the input data for the weak learner machine learning model to generate a synthetic reference curve.

Use of the target well log as the regression objective of the weak learner machine learning model may result in the weak learner machine learning model generating a synthetic version of the target well log as the synthetic reference curve. Use of the reference well logs/depth-shifted well logs as input features may result in the weak learner machine learning model preserving shape characteristics and depth information of the reference well logs/depth-shifted well logs in the synthetic reference curve. Shape characteristics may include changes in shape of the reference well logs/depth-shifted well logs. Shape characteristics may include how the reference well logs/depth-shifted well logs change in shape. For example, shape characteristics may include plateaus, dips, troughs, rises, and/or peaks of the reference well logs/depth-shifted well logs. Depth information may refer to information on locations of shape characteristics. For example, depth information may include locations of plateaus, dips, troughs, rises, and/or peaks of the reference well logs/depth-shifted well logs. While the absolute values of the synthetic reference curve may be a poor substitute for the target well log, the synthetic reference curve may be more like (have higher correlation with) the target well log than any of the reference well logs.

The weak learner machine may capture the relationship between the input reference well log(s) and the target well log so that when the synthetic reference curve is generated for a target well log, the synthetic reference curve has the same/similar shape characteristics as the input reference well log(s), with the shape characteristics matching the direction of the target well log. The scale of the synthetic reference curve may match the scale of the target well log. For example, referring to FIG. 4, the synthetic curve 408 may have a trough and a peak that matches the characteristics of troughs and peaks of the reference curve 402 and the aligned curve 404. The direction in which the synthetic curve 404 changes (e.g., whether the synthetic curve 404 includes a trough or a peak at a particular depth) may match the direction in which the target curve 406 changes.

As shown in FIG. 4, deflections of the synthetic curve 408 go in the same direction as deflections of the target curve 406. The locations and shape of deflections in the synthetic curve 404 may come from the reference curve 402 and the aligned curve 404, while the direction of deflections may come from the target curve 406. The correlation between the target curve 406 and the synthetic curve 408 may be higher than the correlation between the target curve 406 and the reference curve 402 or the aligned curve 404, making the synthetic curve 408 a better reference to depth shift the target curve 406. The synthetic curve 408 enables accurate depth shifting of the target curve 406 even when same type of reference well log is not available.

The depth-shift component 108 may be configured to generate one or more sets of depth-shifted well logs. A set of depth-shifted well logs may include one or more depth-shifted well logs. A set of depth-shifted well logs may be generated by performing depth shifting of a set of target well logs using one or more reference curves and/or other information. Depth shifting a target well log may include changing depth position of information contained in the target well log. For example, a target well log may include a particular value for a specific depth. Depth shifting may raise or lower the depth associated with the particular value. The target well log may be depth shifted so that the depth-shifted curve of the target well log matches and/or is aligned to the reference curve. The target well log may be depth shifted so that the curve of the depth-shifted target well log matches and/or aligned to the reference curve more closely than the original curve of the target well log.

The depth shifting may include iterative use of sliding correlation windows of differing sizes. A sliding correlation window may refer to a window that is used to determine which parts of the target well log and the reference curve will be compared to determine the amount of correlation (e.g., cross-correlation) between different parts of the target well log and the reference curve. A sliding correlation window may refer to a window that is moved over the target well log and the reference curve to enable correlation between different parts of the target well log and the reference curve to be measured/calculated. Rather than attempting to calculate shift values for the entirety of the target well log at once, smaller parts of the target well logs may be analyzed using the sliding correlation window to determine amount and direction of shifting needed for individual parts of the target well log. Parts of the target well logs and parts of the reference curve may be analyzed/compared using convolutional analysis. Sliding correlation windows of differing sizes may be used in different iterations to enable comparison of differently sized parts of the target well log and the reference curve. Decreasing the size of the sliding correlation window with each iteration may enable depth-shifting to become increasingly localized.

The size of the sliding correlation window may be fixed for individual iterations. In some implementations, the sliding correlation windows of differing sizes may include sliding correlation windows of decreasing sizes, such as shown in FIG. 3. That is, with each iteration, the size of the sliding correlation window may be decreased. In some implementations, the sliding correlation windows of differing sizes may include sliding correlation windows of increasing sizes.

In some implementations, a sliding correlation window may be used to determine a depth shift for a target well log based on a cross-correlation between the target well log and the reference curve for depth shifting. For example, the sliding correlation window may be used to calculate windowed cross-correlation between the target well log and the reference curve, which may then be used to determine the amount and direction of shifting at the sampled location in the target well log. For example, shifts between windowed portions of the target well log and the reference curve may be determined using the cross-correlation between the windowed portions.

In some implementations, multiple depth shifts at different scales for a target curve may be combined to perform depth shifting of the target well log to generate a depth-shifted well log. The amount and direction of shifting may be determined (calculated, estimated) at individual sampled locations in the target curve using a sliding correlation window. Effects of noise and resolution mismatch may be mitigated by bandpass filtering the target curve and the reference curve. A light smoother may be applied to all of the shifts to prevent any non-physical over shifting (e.g., prevent depth location A in the well log that is above depth location B in the well log from being shifted below depth location B; prevent depth location C in the well log that is below depth location D in the well log from being shifted above depth location D). The shifts may be added to the depth reference of the target well log, and the target well log may be interpolated to a new depth reference to generate a depth-shifted well log. Interpolation of the shifts may include linear interpolation and/or non-linear interpolation.

The determination and application of depth shifting may be iterated using a smaller-sized sliding correlation window and the depth-shifted well log. With each iteration, shifting of the target well log may be refined. For example, after the first iteration, a first depth-shift well log may be generated. In the second iteration, the first depth-shifted well log may be used in place of the original target well log, and a second depth-shifted well log may be generated. The iterative determination and application depth shifting may continue with smaller sized sliding correlation windows until the smallest sliding correlation window has been used.

In some implementations, a bulk shift may be applied to a target well log before the iterative use of sliding correlation windows of differing sizes. A bulk shift may refer to a single shift that is applied to the target well log to align the target well log to the reference curve. A bulk shift may include a large scale shifting of the target well log to the reference well log. A bulk shift may be calculated using the locations of the target well log and the reference curve with the highest value of correlation (e.g., highest value of cross-correlation).

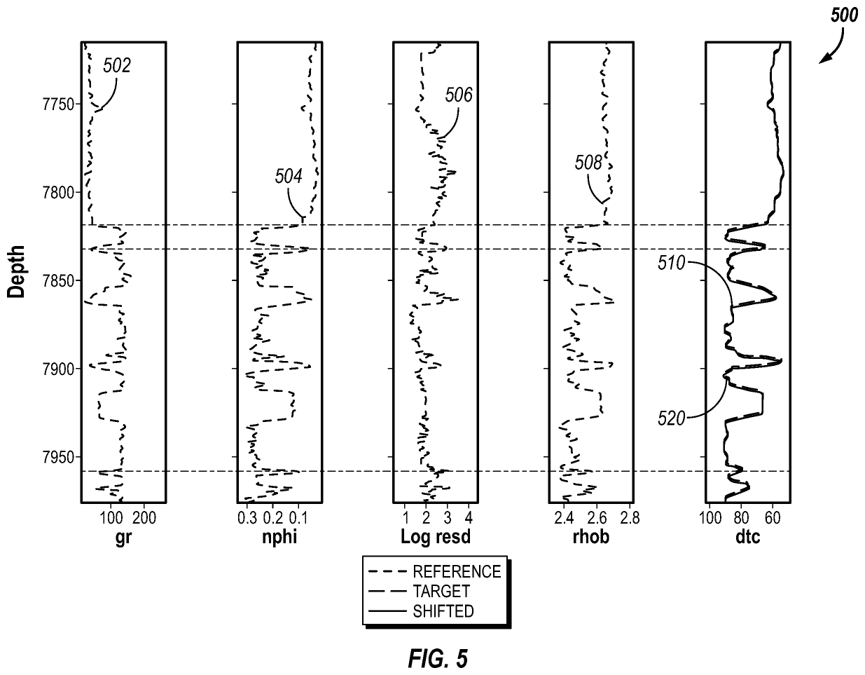

FIG. 5 illustrates example well log depth shifting. Reference well logs 502, 504, 506, 508 may be available to depth shift a target well log 510. One or more of the reference well logs 502, 504, 506, 508 may be depth-shifted well logs. For example, one or more of the reference well logs 502, 504, 506, 508 may have previously been depth shifted using the process 300 shown in FIG. 3.

Rather than using one of the reference well logs 502, 504, 506, 508 to depth shift the target well log 510, the reference well logs 502, 504, 506, 508 may be used as input features for a weak learner machine learning model, with the target well log 510 used as the regression objective. The weak learner machine learning model may generate a synthetic reference curve (synthetic version of the target well log 510) as the reference curve to perform depth shifting of the target well log 510. Depth shifting of the target well log 510 using the synthetic reference curve may result in a depth-shifted well log 520. As shown in FIG. 5, depth shifting of the target well log 510 using the synthetic reference curve may result in correction of bed boundary and peak misalignments of about 3.5 to 5 feet.

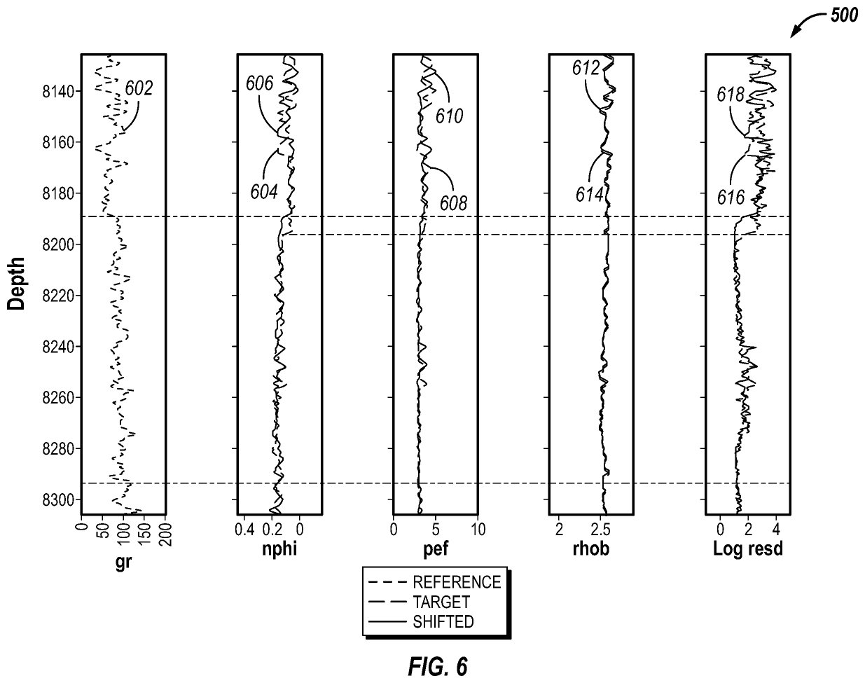

FIG. 6 illustrates example well log depth shifting. A reference well log 602 may be available to depth shift target well logs 604, 608, 612, 616. Low/no correlation may exist between the reference well log 602 and the target well logs 604, 608, 612, 616. Rather than using the reference well log 602 to depth shift the target well logs 604, 608, 612, 616, the reference well log 602 may be used as an input feature for a weak learner machine learning model to generate synthetic versions of the target well logs 604, 608, 612, 616. The synthetic versions of the target well logs 604, 608, 612, 616 may be used as the reference curves to perform depth shifting of the target well logs 604, 608, 612, 616. After depth shifting of a target well log is completed, the depth-shifted well log may be used as an input feature to the weak learner machine learning model. Depth shifting of the target well logs 604, 608, 612, 616 using their respective synthetic reference curve may result in depth-shifted well logs 606, 610, 614, 618. As shown in FIG. 6, depth shifting of the target well logs 604, 608, 612, 616 using their respective synthetic reference curve may result in correction of bed boundary misalignments of about 6.5 to 8 feet.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

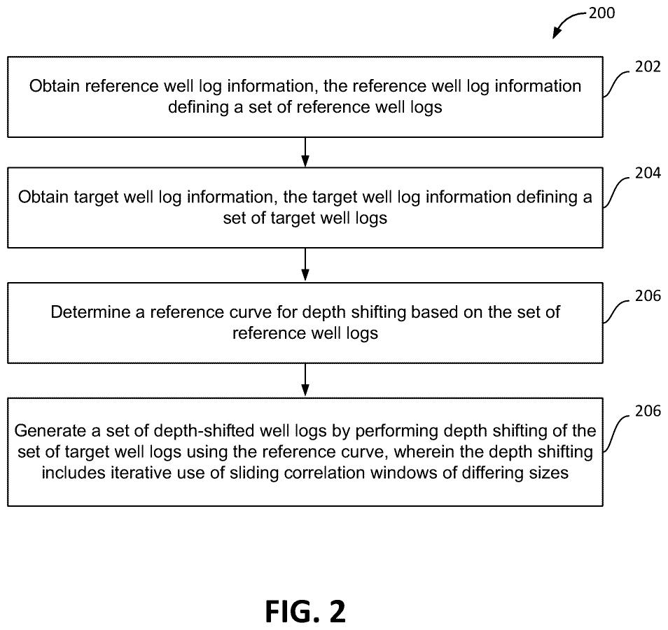

FIG. 2 illustrates method 200 for iterative well log depth shifting. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, reference well log information may be obtained. The reference well log information may define a set of reference well logs. In some implementation, operation 202 may be performed by a processor component the same as or similar to the reference well log component 102 (Shown in FIG. 1 and described herein).

At operation 204, target well log information may be obtained. The target well log information may define a set of target well logs. In some implementation, operation 204 may be performed by a processor component the same as or similar to the target well log component 104 (Shown in FIG. 1 and described herein).

At operation 206, a reference curve for depth shifting may be determined based on the set of reference well logs and/or other information. In some implementation, operation 206 may be performed by a processor component the same as or similar to the reference curve component 106 (Shown in FIG. 1 and described herein).

At operation 208, a set of depth-shifted well logs may be generated by performing depth shifting of the set of target well logs using the reference curve and/or other information. The depth shifting may include iterative use of sliding correlation windows of differing sizes. In some implementation, operation 208 may be performed by a processor component the same as or similar to the depth-shift component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for iterative well log depth shifting, the system comprising:
one or more physical processors configured by machine-readable instructions to:
obtain one or more reference well logs;
obtain a target well loci, wherein the target well log and the one or more reference well logs are of different measurement types;
generate a synthetic reference curve for depth shifting of the target well log that is of different measurement type from the one or more reference well logs by using a weak learner machine learning model, the weak learner machine learning model trained using the one or more references logs as an input feature and the target well loci as a regression objective, wherein the synthetic reference curve output by the weak learner machine learning model is a low quality synthetic copy of the target well log;
generate a depth-shifted well log by performing depth shifting of the target well log using the synthetic reference curve, wherein the depth shifting includes iterative use of sliding correlation windows of differing sizes, further wherein use of the synthetic reference curve to perform the depth shifting results in more accurate depth shifting of the target well loci than use of the one or more reference well logs of different measurement type from the target well loci to perform the depth shifting.

2. The system of claim 1, wherein the sliding correlation windows of differing sizes include sliding correlation windows of decreasing sizes.

3. The system of claim 1, wherein a given sliding correlation window is used to determine a depth shift for a given target well log based on a cross-correlation between the given target well log and the reference curve for depth shifting.

4. The system of claim 3, wherein multiple depth shifts at different scales for the given target well log are combined to perform depth shifting of the given target well log to generate a given depth-shifted well log.

5. (canceled)

6. (canceled)

7. The system of claim 1, wherein the synthetic reference curve output by the weak learner machine learning model being the low quality synthetic copy of the target well log includes absolute values of the synthetic reference curve being a poor substitute for the target well loci while the synthetic reference curve being closer to the target well log than the one or more reference well logs, wherein the synthetic reference curve inherits shape characteristics and depth information of the one or more reference well logs in the synthetic reference curve.

8. (canceled)

9. The system of claim 1, wherein one or more depth-shifted well logs are used as the input feature in training of the weak learner machine learning model.

10. The system of claim 1, wherein a bulk shift is applied to a given target well log before the iterative use of sliding correlation windows of differing sizes.

11. A method for iterative well log depth shifting, the method comprising:
obtaining one or more reference well logs;
obtaining a target well loci, wherein the target well log and the one or more reference well logs are of different measurement types;
generating a synthetic reference curve for depth shifting of the target well loci that is of different measurement type from the one or more reference well logs by using a weak learner machine learning model, the weak learner machine learning model trained using the one or more references logs as an input feature and the target well loci as a regression objective, wherein the synthetic reference curve output by the weak learner machine learning model is a low quality synthetic copy of the target well loci; and
generating a depth-shifted well log by performing depth shifting of the target well log using the synthetic reference curve, wherein the depth shifting includes iterative use of sliding correlation windows of differing sizes, further wherein use of the synthetic reference curve to perform the depth shifting results in more accurate depth shifting of the target well log than use of the one or more reference well logs of different measurement type from the target well log to perform the depth shifting.

12. The method of claim 11, wherein the sliding correlation windows of differing sizes include sliding correlation windows of decreasing sizes.

13. The method of claim 11, wherein a given sliding correlation window is used to determine a depth shift for a given target well log based on a cross-correlation between the given target well log and the reference curve for depth shifting.

14. The method of claim 13, wherein multiple depth shifts at different scales for the given target well log are combined to perform depth shifting of the given target well log to generate a given depth-shifted well log.

15. (canceled)

16. (canceled)

17. The method of claim 11, wherein the synthetic reference curve output by the weak learner machine learning model being the low quality synthetic copy of the target well log includes absolute values of the synthetic reference curve being a poor substitute for the target well loci while the synthetic reference curve being closer to the target well log than the one or more reference well logs, wherein the synthetic reference curve inherits shape characteristics and depth information of the one or more reference well logs.

18. (canceled)

19. The method of claim 11, wherein one or more depth-shifted well logs are used as the input feature in training of the weak learner machine learning model.

20. The method of claim 11, wherein a bulk shift is applied to a given target well log before the iterative use of sliding correlation windows of differing sizes.

21. The system of claim 7, wherein the synthetic reference curve inheriting the shape characteristics of the one or more reference well logs includes the synthetic reference curve inheriting shapes of plateaus, dips, troughs, rises, and/or peaks of the one or more reference well logs.

22. The system of claim 21, wherein the synthetic reference curve inheriting the depth information of the one or more reference well logs includes the synthetic reference curve inheriting locations of the plateaus, the dips, the troughs, the rises, and/or the peaks of the one or more reference well logs.

23. The system of claim 22, wherein the synthetic reference curve inheriting the shape characteristics and the depth information of the one or more reference well logs includes overall shape of the synthetic reference curve being determined based on overall shape of the one or more reference well logs while direction of changes in the synthetic reference curve matches direction of changes in the target well log.

24. The method of claim 17, wherein the synthetic reference curve inheriting the shape characteristics of the one or more reference well logs includes the synthetic reference curve inheriting shapes of plateaus, dips, troughs, rises, and/or peaks of the one or more reference well logs.

25. The method of claim 24, wherein the synthetic reference curve inheriting the depth information of the one or more reference well logs includes the synthetic reference curve inheriting locations of the plateaus, the dips, the troughs, the rises, and/or the peaks of the one or more reference well logs.

26. The method of claim 25, wherein the synthetic reference curve inheriting the shape characteristics and the depth information of the one or more reference well logs includes overall shape of the synthetic reference curve being determined based on overall shape of the one or more reference well logs while direction of changes in the synthetic reference curve matches direction of changes in the target well log.
